(19) United States
(12) Patent Application Publication
(10) Pub. No.: US 2021/0273500 A1
(43) Pub. Date: Sep. 2, 2021

(54) ELECTRIFIED VEHICLE ELECTRIC MACHINE STATOR

(71) Applicant: FORD GLOBAL TECHNOLOGIES, LLC, Dearborn, MI (US)

(72) Inventors: Chuan DENG, Nanjing (CN); Guohua DU, Nanjing (CN); Yigang YUAN, Nanjing (CN)

(73) Assignee: FORD GLOBAL TECHNOLOGIES, LLC, Dearborn, MI (US)

(21) Appl. No.: 17/183,544

(22) Filed: Feb. 24, 2021

(30) Foreign Application Priority Data
Feb. 28, 2020 (CN) 2020101305394

(51) Int. Cl. H02K 1/16; H02K 15/085; H02K 3/12

(52) U.S. Cl. CPC H02K 1/165; H02K 3/12; H02K 15/085

(57) ABSTRACT

A multi-phase electric machine for an electrified vehicle includes a stator having multiple slots for accommodating windings. The slots extend radially between the inner circumference and the outer circumference of the stator and include open slots and closed slots arranged such that the windings of each phase occupy at least one open slot and at least one closed slot. A method for reducing torque ripple in a multi-phase electric machine includes winding a conductor through a stator having open slots and closed slots wherein each phase winding passes through at least one open slot and one closed slot.

### CROSS-REFERENCE TO RELATED APPLICATIONS

This application claims foreign priority benefits under 35 U.S.C. § 119(a)-(d) to CN Application 2020 101 305 394 filed Feb. 28, 2020, which is hereby incorporated by reference in its entirety.

### TECHNICAL FIELD

The present disclosure generally relates to the technical field of a vehicle, and more specifically to a stator of a motor, a motor comprising the stator and a method for reducing torque ripple of a motor.

### BACKGROUND

In the design and manufacture of modern vehicles, electric vehicles have developed rapidly. Vehicles such as battery electric vehicles (BEV), plug-in electric vehicles (PHEV) and hybrid electric vehicles (HEV) employ motors for driving wheels.

An electrical machine converts electrical energy into mechanical motion or vice versa by the coordinated operation of a stator and a rotor. The electrical machine comprises a rotor and a stator around the rotor. The stator may have multiple slots, and each of the multiple slots has a cross-sectional area to accommodate windings which occupy the inner space of the slots. The stator windings are energized to form a rotating magnetic field and the magnets comprised in the rotor rotate under the action of the magnetic field which drives the rotor to rotate.

The noise, vibration and harshness (NVH) performance of the vehicle transmission is very sensitive to high-order torque ripple harmonics of the electric machine, especially the 48th order. Therefore, in the design of the electric machine or motor, it is desirable to reduce the torque ripple harmonics of the motor, especially the 48th order.

Typically, the motor torque ripple can be reduced by the optimization of the stator and the rotor. In terms of the rotor, the conventional methods to reduce the torque ripple comprise the deflection of the magnet and the optimization of the rotor edge. In terms of the stator, skewed slots in the stator are proved effective to reduce the target torque ripple, but the skewed slots will increase the cost of the winding. Another conventional method is to configure all the slots with open structure to reduce the torque ripple, but the result is often undesirable.

It is desirable that the NVH performance of the vehicle could be improved with reduced torque ripple and at the same time be more cost-effective.

### SUMMARY

The present disclosure summarizes aspects of the representative embodiments and should not be used to unnecessarily limit the claims as they would be interpreted by those of ordinary skill in the art. Other implementations are contemplated in accordance with the techniques described herein, as will be apparent to those of ordinary skill in the art upon examination of the associated drawings and detailed description, and such implementations are intended to be within the scope of the claims.

One advantage of various embodiments of an electric machine stator, an electric machine, and/or a method of the present disclosure is reducing the torque ripple of the electric machine to improve the NVH performance of the vehicle.

According to an aspect of the present disclosure, a stator of an electric machine includes multiple slot types for accommodating windings, wherein the slots extend radially between the inner circumference and the outer circumference of the stator, the slots comprise an open slot type and a closed slot type, and the open slot type has an opening at the inner circumference; and wherein the multiple slots and the windings form multiple phases, the winding of each of the multiple phases occupies at least two slots, and the at least two slots comprise an open-ended slot and a closed-ended slot.

According to an embodiment of the present disclosure, the multiple phases comprise a U phase, a V phase, and a W phase, the windings of which occupy the multiple slots of the stator in a sequence of the U phase, the V phase, and the W phase.

According to embodiments of the present disclosure, the windings of the U phase, the V phase and the W phase are connected in series or in parallel.

According to embodiments of the present disclosure, the winding of each of the U phase, the V phase and the W phase occupies two slots, and the two slots comprise one open slot and one closed slot.

According to an embodiment of the present disclosure, in the slots occupied by the windings of any of the U phase, the V phase and the W phase, an open slot is followed by or immediately adjacent to a closed slot. In one embodiment, an open slot has closed slots immediately adjacent in both circumferential directions.

According to an embodiment of the present disclosure, in the slots occupied by the windings of the U phase and the W phase, the open slot is followed by the closed slot, and in the slots occupied by the winding of the V phase, the closed slot is followed by the open slot along a specified circumferential direction.

According to an embodiment of the present disclosure, in the slots occupied by the windings of the U phase and the V phase, the closed slot is followed by the open slot, and in the slots occupied by the winding of the W phase, the open slot is followed by the closed slot.

According to an embodiment of the present disclosure, the winding of each of the multiple phases occupies three slots, and the ratio of the open slot to the closed slot in the three slots is 2:1 or 1:2. In one embodiment, the three slots are three consecutive or adjacent slots.

According to an embodiment of the present disclosure, the winding of each of the multiple phases occupies four slots, and the ratio of the open slot to the closed slot in the four slots is 1:1, 1:3 or 3:1. In one embodiment, the four slots are four consecutive or adjacent slots.

According to another aspect of the present disclosure, a motor comprises a stator and a rotor, wherein the stator surrounds the rotor and an air gap is disposed between the inner circumference of the stator and the outer circumference of the rotor; wherein the stator comprises multiple slots for accommodating windings, the multiple slots extending radially between the inner circumference and the outer circumference of the stator, the slots comprising an open slot and a closed slot, and the open slot has an opening at the inner circumference; and wherein the multiple slots and the windings form multiple phases, the winding of each of the multiple phases occupies at least two slots, and the at least two slots comprise at least one open slot and at least one closed slot.

According to an embodiment of the present disclosure, the multiple slots and the windings form eight poles and three phases, and the three phases designated as a U phase, a V phase and a W phase, respectively.

According to an embodiment of the present disclosure, the winding of each of the first, second, and third phases occupies two slots, and the two slots comprise one open slot and one closed slot. According to an embodiment of the present disclosure, in the slots occupied by the windings of the U phase, the V phase and the W phase, the open slot is followed by the closed slot.

According to an embodiment of the present disclosure, in the slots occupied by the windings of the U phase and the W phase, the open slot is followed by or adjacent to the closed slot, and in the slots occupied by the winding of the V phase, the closed slot is followed by or adjacent to the open slot.

According to an embodiment of the present disclosure, in the slots occupied by the windings of the U phase and the V phase, the closed slot is followed by the open slot, and in the slots occupied by the winding of the W phase, the open slot is followed by the closed slot.

According to yet another aspect of the present disclosure, a method for reducing torque ripple of a motor includes providing a stator with an inner circumference suitable for surrounding a rotor; providing multiple slots radially extending between the inner circumference and the outer circumference of the stator, wherein the multiple slots accommodate windings and comprise an open-ended slot and a closed-ended slot; forming multiple phases by the multiple slots and the windings; and arranging the winding of each of the multiple phases to occupy at least two slots, wherein the at least two slots comprise the open slot and the closed slot.

According to various embodiments of the disclosure, the windings may be connected in series or in parallel.

According to an embodiment of the disclosure, the multiple phases comprise U phase, V phase, and W phase, and the U phase, V phase and W phase are arranged repeatedly in sequence.

According to yet another aspect of the present disclosure, a stator of a motor comprises multiple slots for accommodating windings, wherein the multiple slots comprise an open slot and a closed slot.

According to an embodiment of the disclosure, the multiple slots and the windings form multiple phases, and the slots occupied by the winding of each of the multiple phases comprise an open slot and a closed slot.

For a better understanding of the present disclosure, reference can be made to the embodiments shown in the associated figures. The components in the figures are not necessarily drawn to scale and some components may be omitted or in some cases the proportions may have been magnified to highlight and clearly show the features described in this disclosure. In addition, as known in the art, system components can be arranged differently, or combined from various embodiments to form additional embodiments that are not illustrated or described, but would be understood by those of ordinary skill in the art. In addition, identical elements/parts/components may also have the same reference numerals throughout the figures.

### BRIEF DESCRIPTION OF THE DRAWINGS

FIGS. 1A and 1B show the transmission noise diagram of the 24th and 48th order torque ripple harmonics for an electric machine at different torques according to the prior art;

FIG. 2 shows the schematic diagram of the motor stator according to the prior art;

FIG. 3A shows the stator windings arranged in the stator slots according to one embodiment of the disclosure;

FIG. 3B shows an enlarged view taken from the area A in FIG. 3A;

FIG. 4 shows a schematic diagram of a slot with open structure according to various embodiments of the disclosure; and

FIG. 5 shows a schematic diagram of slots with closed structures according to various embodiments of the disclosure.

### DETAILED DESCRIPTION

As required, detailed embodiments are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

The following describes representative embodiments of this disclosure. However, it should be understood that the disclosed embodiments are only examples and that other embodiments may take various alternative forms. The drawings are not necessarily drawn to scale; certain features may be exaggerated or minimized to show the details of a particular part. Therefore, the specific structural and functional details disclosed in this disclosure should not be interpreted as limitations, but only as examples for explaining how to use the disclosure in various ways. As will be understood by those skilled in the art, the description which is described with reference to any of the features shown in the figures may be combined with the features shown in one or more other figures to form embodiments that may not be explicitly described or illustrated. The combination of the features shown provides some embodiments for typical applications. However, various combinations and modifications of embodiments may be expected without departing from the scope of the claimed subj ect matter.

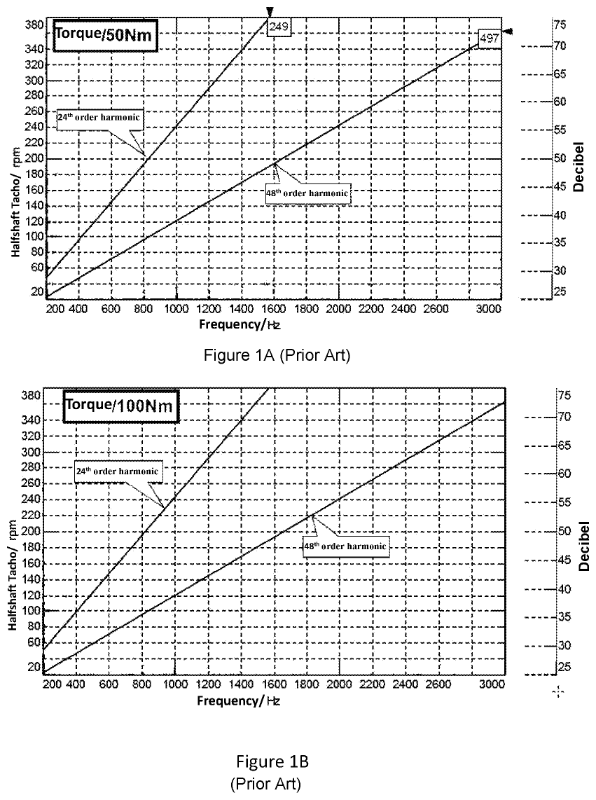

With reference to FIGS. 1A and 1B, transmission noise diagrams of the 24th and 48th order torque ripple harmonics of a motor at different torques according to the prior art are shown. The upper view of FIG. 1A is a schematic diagram of the 24th and 48th order torque ripple harmonic of a motor at a torque of 50 Nm in the coordinate system of half shaft tachometer/frequency/decibel. The half shaft tachometer is the speed of the output shaft of the transmission measured by a speed sensor. As can be seen, with the increase of the speed, the corresponding frequencies of the 24th and 48th order torque ripple harmonic of a motor and the decibels of noise also become higher. That is, they are positively correlated. The lower view of FIG. 1B shows a schematic diagram of the 24th and 48th order torque ripple harmonic of a motor at a torque of 100 Nm. It shows the same problem. The inventor has realized that the performance of noise, vibration and harshness (NVH) of the vehicle transmission is very sensitive to the higher order motor torque ripple harmonics of the motor, especially the 24th and 48th orders. Therefore, it is desirable to reduce the motor torque ripple harmonics of higher order, especially the 24th and 48th order harmonics.

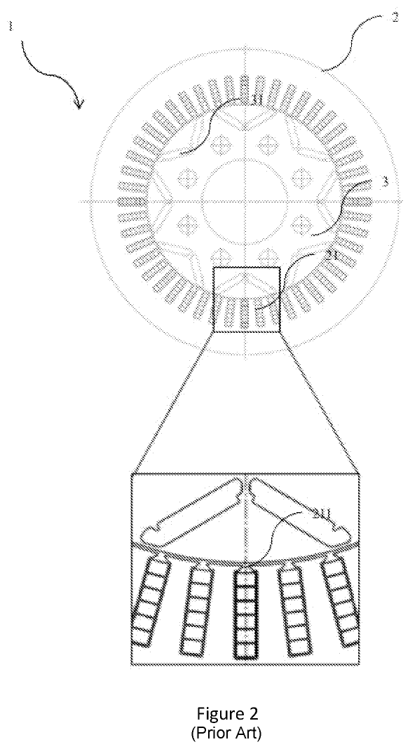

With reference to FIG. 2, a schematic diagram of the stator and the rotor of a motor according to the prior art is shown. As can be seen, the motor 1 comprises a stator 2 and a rotor 3. The stator 2 is arranged around the rotor 3, and there is an air gap between the stator 2 and the rotor 3. The rotor 3 can be connected to a shaft (not shown) to output the rotation. The stator 2 comprises a plurality of slots 21 to accommodate windings. The slots 21 extend radially outward from the inner circumference of the stator 2. In the existing stator 2, the stator slots are all open slots containing openings 211. The rotor 3 may include a housing portion accommodating a permanent magnet 31. The permanent magnet 31 can be arranged in pairs to form magnetic poles. The number of slots 21 can be correlated with the number of the pairs of the permanent magnet 31 so that the number of slots 21 per phase for one pole is an integer. In this case, the configuration of the slots 21 of the stator 2 which are all open structures is undesirable to reduce the torque ripple.

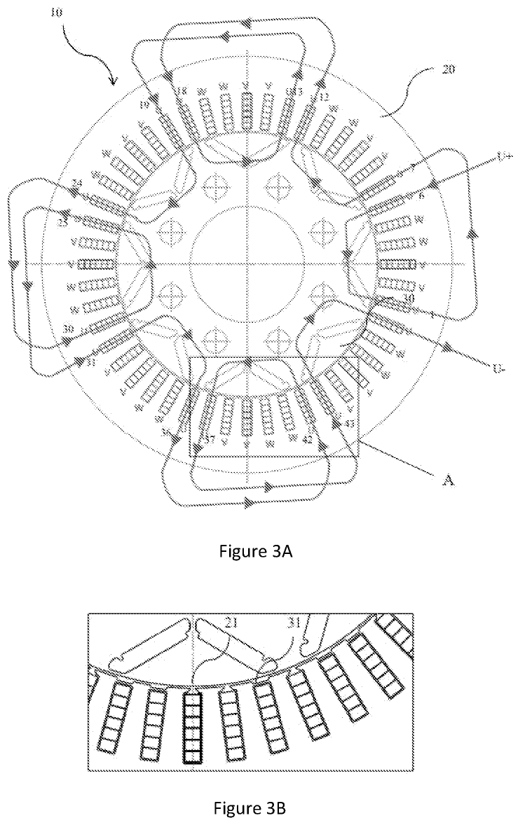

FIGS. 3A and 3B show the stator windings arranged in the stator slots according to one embodiment of the disclosure. In this embodiment, the motor is shown as a three-phase motor as an example. The motor 10 comprises a stator 20 and a rotor 30. The stator 20 surrounds the rotor 30 and an air gap is disposed between the stator 20 and the rotor 30. In this embodiment, at least two slots are assigned for the winding of each phase U, V, and W. Taking the winding arrangement of the U phase as an example, the slots comprise an open slot 21 and a closed slot 31 as shown in FIG. 3B. In the present embodiment, the stator 20 of the three-phase motor comprises 48 stator slots and FIG. 3A shows the winding arrangement of the U phase winding.

For better understanding the winding arrangement of the stator 20, assuming that the winding begins at the terminal U+ shown in FIG. 3A and the slots are sorted counterclockwise with numbers # 1-48 (some numbers are omitted for clarity), the winding first enters into the slot # 6, then extends toward slot # 1 on the inner side of the stator 20 and enters into slot 1. The winding passes through slot # 1 and then extends toward slot # 7 on the outside of the stator 20. The winding passes through slot # 7 and then extends toward slot # 12 on the inner side of the stator 20. The winding extends on the outside of the stator 20 after it passes through slot # 12 and then run into slot # 18. After this, the winding passes through slot # 13 and slot # 19 in a similar way. And then, the winding passes through slot # 24, slot # 30, slot # 25, slot # 31, slot # 36, slot # 42, slot # 37, and slot # 43 in a similar way. Finally, the winding passes through slot # 48 and arrive at a terminal U-. This realizes the winding arrangement of the U phase. It will be appreciated that the winding arrangement of the V and W phases of the three-phase motor has similar configuration. FIG. 3A shows the slots occupied by the winding of U, V, and W phase respectively in an assembled motor, wherein the slots occupied by the windings of U phase, V phase, and W phase are represented by U, V, and W, respectively.

To reduce torque ripple, different arrangements of slots are investigated under the principle of ensuring that each phase includes at least one open slot 21 and at least one closed slot 31 as best illustrated in FIG. 3B. The arrangements of open and closed slots for 6 adjacent slots is shown in Table 1 wherein the symbol ● represents the open slot and the symbol ∘ represents the closed slot. The patterns represented in Table 1 are repeated around the circumference of the stator eight times in this example to provide a total of 48 slots with 24 open slots and 24 closed slots as follows:

TABLE 1

| | U | U | V | V | W | W |
|---|---|---|---|---|---|---|
| Prior art | ● | ● | ● | ● | ● | ● |
| Arrangement 1 | ● | ◯ | ● | ◯ | ● | ◯ |
| Arrangement 2 | ● | ◯ | ◯ | ● | ● | ◯ |
| Arrangement 3 | ◯ | ● | ◯ | ● | ● | ◯ |

The prior art arrangement with all slots open, and three different arrangements according to embodiments of the present disclosure labeled as Arrangement 1-3 are shown in Table 1. As can be seen, the slots of the stator for the motor in the prior art are all open slots. While in the Arrangements 1-3, the slots for each of the eight sectors of the U phase, the V phase and the W phase comprise one open slot and one closed slot. The embodiment shown in FIG. 3A of this disclosure takes Arrangement 2 as an example, but it should be understood that other arrangements also fall within the scope of this disclosure.

As shown in FIG. 3A, take the sector from slot # 42 to slot # 48 as an example. The arrangement of the slots is “an open slot, a closed slot, a closed slot, an open slot, an open slot, and a closed slot”. It is arranged completely in accordance with the above mentioned Arrangement 2. That is to say, every six slots of the 48 slots are considered to be a group or sector and the six slots in each group or sector are arranged according to the arrangement of the six slots for three different phases shown in the above mentioned Arrangement 2.

FIG. 3B shows an enlarged view taken from the area A in FIG. 3A. It shows the structure of the slots in more detail. In can be seen that, the open slot 21 has an opening toward the air gap, while the closed slot 31 does not have a similar opening. It is appreciated that, in the three-phase motor shown in this embodiment, the winding arrangement configures each phase to occupy only two slots in each group or sector, but in other different arrangements, it is also possible for each phase to occupy more slots, such as three slots or four slots. When each phase occupies three slots, the ratio of the closed slot to the open slot can be 2:1 or 1:2. It is also appreciated that, when each phase occupies four slots, the ratio of the closed slot to the open slot can be 3:1, 1:3 or 1:1. It is further appreciated that, in the case of each phase occupying more than four slots, there may also be more combinations within the scope of the claims based on the disclosed principle that each phase occupies at least one open slot and at least one closed slot. The principles may also be extended to motors having more than three phases, such as a six-phase motor as one example.

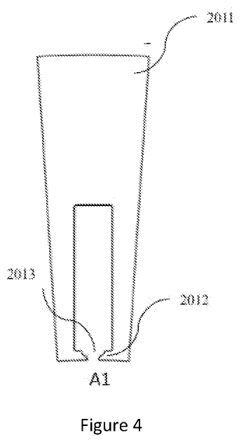

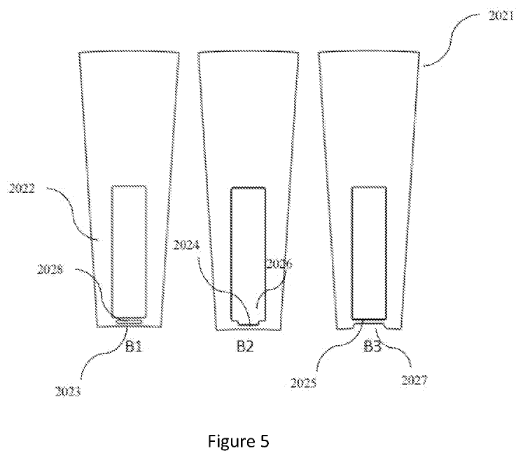

As shown in FIG. 4 and FIG. 5, the structures of the multiple closed slots B1, B2, B3 and the open slot A1 are shown in these figures. The open slot A1 shown in FIG. 4 comprises a body 2011, which constitutes a part of the body of the stator 20. The open slot A1 extends radially outward from the inner circumference of the stator 20. In this embodiment, the open slot A1 has a substantially rectangular shape. At the inner end of the open slot A1, two protruding portions 2012 are disposed opposite. The two protruding portions 2012 extend toward each other and a gap which defines the opening 2013 of the stator slot is disposed between the two protruding portions 2012. It is also appreciated that, other forms of stator slots with openings facing the inner side of the stator 20 are also possible and included in the range of this disclosure.

With reference to FIG. 5, the closed slots B1-B3 are shown in this figure. Each of the closed slots B1-B3 also comprises a body which constitutes a part of the body of the stator 20. The closed slot B1 has a substantially rectangular shape. It has a through hole extending radially outward from the portion adjacent to the inner circumference of the stator 20. And the portion of the closed slots B1-B3 in vicinity of the inner circumference of the stator 20 does not have an opening which is open into the inner side of the body of the stator 20. In other words, each of the closed slots B1-B3 further comprises a transverse portion 2023 which is located at the inner circumference of the stator 20. Another elongated through hole 2028 extending in circumferential direction is disposed between the inner end of the radially extending through hole and the inner circumference of the stator 20. It can be appreciated that, the shape and the size of the elongated through hole 2028 can have different configurations. The structure of the elongated through hole 2028 can be made reference to the CN Application No. 2019100700548, which is hereby incorporated by reference in its entirety. The closed slot B2 also has a substantially rectangular shape and has a through hole extending radially outward from the portion adjacent to the inner circumference of the stator 20. The inner end of the closed slot B2 comprises a transverse portion 2024. Different from closed slot B1, the transverse portion 2024 of the closed slot B2 has no through hole. The through hole of the closed slot B2 at the inner end has a recess 2026 extending radially toward the transverse portion 2024. The closed slot B3 also has a substantially rectangular shape and has a through hole extending radially outward from the portion adjacent to the inner circumference of the stator 20. The inner end of the closed slot B3 also comprises a transverse portion 2025. Different from the closed slot B2, the transverse portion 2025 of the closed slot B3 has a recess at the inner circumference of the stator 20, which forms a depression 2027 of the circumference of the stator 20.

In addition to the arrangements of the closed and open slots shown in the Arrangements 1-3 in table 1, other arrangements which can reduce the torque ripple are also possible. When the motor operates at the torque of 235 Nm and the speed of 1000 rpm, data show that the Arrangements 1-3 of the open slot A1 and the closed slots B1-B3 enable the 48th order torque ripple harmonic to be reduced by 3.559%-3.664%, and the 96th order torque ripple harmonic to be reduced by 15.12%-54.96%. Thus, the torque ripple harmonic of the 48th and 96th order are both obviously decreased compared with the current arrangements of the stator in the prior art.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The term “including” is inclusive and has the same scope as “comprising”.

The above-mentioned embodiments are possible examples of implementations of the claimed subject matter and are given only for the purpose of enabling those skilled in the art to clearly understand the principles thereof. It should be understood by those skilled in the art that the above discussion to any embodiment is only illustrative, and is not intended to imply that the disclosed scope of the embodiments or claims is limited to these examples. The technical features in the above embodiments or different embodiments can be combined with each other to produce many other changes in different aspects of embodiments that are not provided in the detailed description for the sake of brevity. Therefore, any omission, modification, equivalent replacement, improvement, etc. made within the spirit and principle of the described embodiments shall be included in the scope of protection of the claims.

While representative embodiments are described above, it is not intended that these embodiments describe all possible forms of the claimed subject matter. The words used in the specification are words of description rather than limitation, and it is understood that various changes may be made without departing from the spirit and scope of the claimed subject matter.

What is claimed is:

1. An multi-phase motor stator comprising a plurality of slots configured to accommodate windings associated with multiple phases, the slots extending radially between an inner circumference and an outer circumference of the stator, the slots including open slots having an opening at the inner circumference and closed slots that are closed at the inner circumference, wherein the slots are arranged with at least one open slot and at least one closed slot associated with the windings for each of the multiple phases.

2. The multi-phase motor stator of claim 1 wherein the plurality of slots are circumferentially arranged such that every open slot is adjacent to at least one closed slot.

3. The multi-phase motor stator of claim 2 wherein every closed slot is adjacent to at least one open slot.

4. The multi-phase motor stator of claim 1, wherein the plurality of slots are arranged in multiple groups of adjacent slots associated with each phase and wherein each group of adjacent slots comprises one open slot and one closed slot.

5. The multi-phase motor stator of claim 4 wherein each group of adjacent slots includes three adjacent slots associated with the same phase.

6. The multi-phase motor stator of claim 5, wherein a ratio of open slots to closed slots is 2:1 or 1:2.

7. The multi-phase motor stator of claim 4, wherein each group of adjacent slots includes four adjacent slots associated with the same phase and wherein a ratio of open slots to closed slots is 3:1 or 1:3 or 1:1.

8. The multi-phase motor stator of claim 1, wherein a ratio of the open slots to the closed slots is 1:1.

9. The multi-phase motor stator of claim 1, wherein the open slots are arranged in an alternating pattern with the closed slots such that every open slot has two adjacent closed slots and every closed slot has two adjacent open slots.

10. An electric machine comprising:
a rotor; and
a stator surrounding the rotor and defining an air gap disposed between an inner circumference of the stator and an outer circumference of the rotor, the stator defining a plurality of radially extending slots configured to accommodate windings having an associated phase, the slots including open slots having an opening to the air gap and closes slots that are closed to the air gap, wherein the open slots and closed slots are arranged such that the windings for each phase occupy both open slots and closed slots.

11. The electric machine of claim 10 wherein the closed slots are equal in number to the open slots.

12. The electric machine of claim 10 wherein each open slot is adjacent to at least one of the closed slots.

13. The electric machine of claim 12 wherein each open slot is adjacent to two of the closed slots.

14. The electric machine of claim 10 wherein the plurality of slots are arranged in multiple groups of adjacent slots associated with each phase, wherein each of the multiple groups includes at least one of the open slots and at least one of the closed slots.

15. The electric machine of claim 14 wherein each of the multiple groups includes three adjacent slots and a ratio of the closed slots to the open slots is 1:2 or 2:1.

16. The electric machine of claim 10 wherein the closed slots and open slots are arranged in an alternating manner such that each closed slot is adjacent to two open slots.

17. A method comprising:
positioning windings for each phase of an electric machine within slots of a stator such that the windings of each phase occupy both open slots having an opening to an air gap between the stator and a rotor of the electric machine and closed slots that are closed to the air gap.

18. The method of claim 17 wherein the open slots and closed slots are arranged in an alternating manner.

19. The method of claim 17 wherein every open slot is adjacent to at least one closed slot.

20. The method of claim 17 wherein every closed slot is adjacent to at least one open slot.
